(19) United States
(12) Patent Application Publication
(10) Pub. No.: US 2025/0235027 A1
(43) Pub. Date: Jul. 24, 2025

(54) GUARD FOR COOKING SYSTEM

(71) Applicant: SHARKNINJA OPERATING LLC, Needham, MA (US)

(72) Inventor: Joshua D. Anthony, Billerica, MA (US)

(21) Appl. No.: 19/056,294

(22) Filed: Feb. 18, 2025

Related U.S. Application Data
(63) Continuation of application No. 18/453,035, filed on Aug. 21, 2023, now Pat. No. 12,226,039.
Application No. 18/453,035 is a division of application No. 16/800,476, filed on Feb. 25, 2020, now Pat. No. 11,751,710.
(60) Provisional application No. 62/810,254, filed on Feb. 25, 2019.

(51) Int. Cl. A47J 27/00; A47J 36/06; A47J 37/06; F24C 15/32; F24C 15/36

(52) U.S. Cl. CPC A47J 27/002; A47J 36/06; A47J 37/0641; A47J 37/0664; F24C 15/322; F24C 15/36

(57) ABSTRACT

A cooking system including a housing having a hollow interior, a heating element associated with said housing, a support body for supporting the food within said hollow interior such that the food is positionable on a support surface of said support body, and a guard located between at least a portion of the support surface and said heating element. The guard is permissive of convective airflow between said hollow interior and said heating element, and is generally impermeable to projectile matter generated during a cooking operation.

### CROSS-REFERENCE TO RELATED APPLICATIONS

This application is a continuation of U.S. application Ser. No. 18/453,035, filed Aug. 21, 2023, set to issue as U.S. Pat. No. 12,226,039 on Feb. 18, 2025, and entitled “GUARD FOR COOKING SYSTEM,” which is a divisional of U.S. application Ser. No. 16/800,476, filed on Feb. 25, 2020 and entitled “GUARD FOR COOKING SYSTEM,” now U.S. Pat. No. 11,751,710, which claims priority to U.S. Provisional Application Ser. No. 62/810,254, filed Feb. 25, 2019, the entire contents of which are incorporated herein by reference.

### BACKGROUND

Embodiments of the present disclosure relate generally to a cooking system, and more particularly, to a guard for blocking a flow of fat or oil from contacting a heating element of a cooking system.

### SUMMARY

According to an embodiment, a cooking system including a housing having a hollow interior, a heating element associated with said housing, a support body for supporting the food within said hollow interior such that the food is positionable on a support surface of said support body, and a guard located between at least a portion of the support surface and said heating element. The guard is permissive of convective airflow between said hollow interior and said heating element, and is generally impermeable to projectile matter generated during a cooking operation.

According to yet another embodiment, a cooking system includes a housing having a hollow interior, a first heating element associated with said housing and operable in a first cooking mode, a second heating element associated with said housing and operable in a second cooking mode, and a guard configurable with said housing to be permissive of convective airflow between said hollow interior and said heating element during said first cooking mode, and non-permissive of convective airflow between said hollow interior and said heating element during said second cooking mode.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1 is a plan view of a guard for use with a cooking system according to an embodiment;

FIG. 2 is a schematic view of the guard of FIG. 1 according to an embodiment;

FIG. 3 is a schematic diagram of a cooking system including a guard according to an embodiment;

FIG. 4 is a front perspective view of a cooking system according to an embodiment;

FIG. 5 is a perspective view of a lid of a cooking system according to an embodiment; and

FIG. 6 is a schematic diagram of a control system associated with a guard of a cooking system according to an embodiment.

The detailed description explains embodiments of the disclosure, together with advantages and features, by way of example with reference to the drawings.

### DETAILED DESCRIPTION

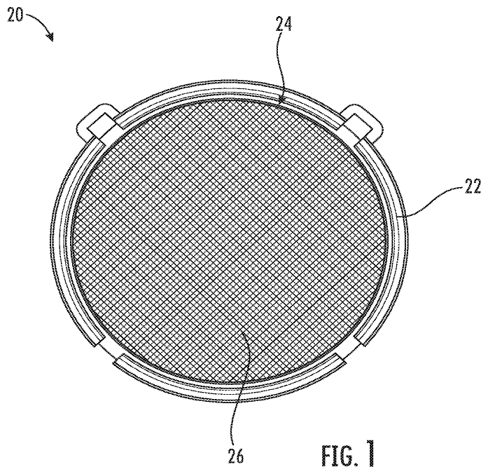

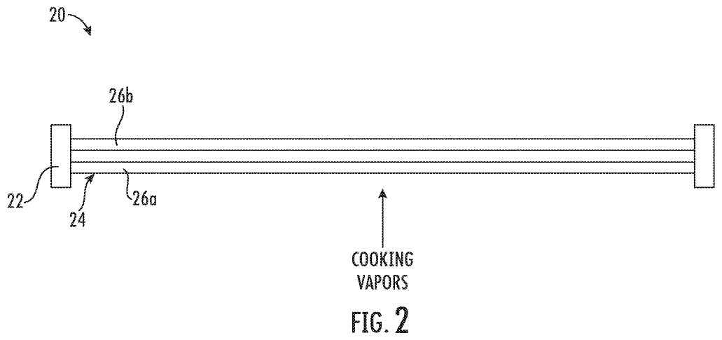

With reference now to FIGS. 1 and 2, an example of a guard 20 for use during a cooking operation is illustrated. As shown, the guard 20 includes a frame 22 and a body 24 formed from at least one layer of material 26 mounted within the frame 22. In the illustrated, non-limiting embodiment, the body 24 includes a first layer 26a and a second layer 26b (FIG. 2). However, it should be understood that a guard 20 having a body 24 including only single layer of material, or alternatively, more than two layers of material are also within the scope of the disclosure.

The at least one layer 26 of the body 24 is permeable to air and water vapor. The layer 26 may be selected from any suitable heat-resistant material. In an embodiment, the material used to form one or more of the layers 26 of the body 24 is a non-absorbent material, such as a metal wire mesh for example. The configuration of the mesh, such as the size of the apertures of the mesh for example, is selected such that projectile matter generated during a cooking operation, such as fat or oil for example, is substantially blocked from passage through the apertures. However, the sizes of the apertures may also be selected to allow a flow of air and heat, sufficient for performing a convective cooking operation for example, to pass through the material. In an embodiment using two layers, the mesh material of each layer 26a and 26b may be formed from a braided or welded metal wire having a diameter of 4 mm to .5 mm, with openings of .8 mm to 2.1 mm. More specifically, each layer 26a and 26b may be formed from a braided or welded metal wire having a diameter of about .45 mm, with openings of about 1.5 mm. The layers 26a and 26b may be aligned such that the openings between the overlapping layers are .4 mm to 2.1 mm, and more specifically .4 mm to 1.5 mm, 4 mm to .75 mm, and .75 mm to 1.5 mm.

Heat-resistant, non-absorbent materials that are non-metallic, such as silicone for example, are also within the scope of the disclosure. In such embodiments, the layer 26 may similarly have a plurality of openings or apertures formed therein. Further, any material that is capable of being chemically treated to achieve desired heat-resistant and non-absorbent properties is also within the scope of the disclosure.

Alternatively, in addition to being vapor-permeable, the material of one or more of the layers of the body may be liquid or grease-absorbent. Examples of such materials, includes, but are not limited to, a vapor-permeable cloth, such as a textile cloth, or a cellulose cloth. The various types of materials illustrated and described herein are intended as an example only, and it should be understood that any material suitable to block a flow of projectile matter is contemplated herein.

With reference to FIG. 2, in embodiments where the body 24 of the guard 20 includes multiple layers, the plurality of layers of material 26 are stacked along a flow path of cooking vapors generated during a cooking operation. Although the first and second layers 26a, 26b are shown as being spaced from one another along the flow path, embodiments where adjacent layers are arranged in direct contact with one another are also contemplated herein.

Each of the layers 26 of the body 24 may be formed from a similar material or a different material. In addition, the layers 26 may have similar or different configurations and/or orientations. For example, a gauge of a first layer 26a of mesh may be different than the gauge of a second layer 26b of mesh. Further, the first and second layers 26a, 26b may be arranged such that apertures of the first layer 26a are generally aligned with the apertures of the second layer 26b. Alternatively, the material of the second layer 26b may be shifted or rotated relative to the material of the first layer 26a such that the apertures of the first layer 26a are staggered or offset from the apertures of the second layer 26b. In such embodiments, the apertures of the first layer 26a and the apertures of the second layer 26b cooperate to define an open area of the body 24 through which a fluid, such as air or vapor, may pass.

A configuration of the body 24 may be adjustable to control the permeability of the body 24, for example based on the cooking operation being performed. In an embodiment, a configuration of one or more layers 26 may be adjustable to achieve any configuration of the body 24 between a fully open configuration and a fully closed configuration. In the fully open configuration, the body 24 may be permeable not only to cooking vapors and air flow, but also projectile material, and in the fully closed configuration, the body 24 may be impermeable to all flows including projectile matter, cooking vapors, air, and heat. In an embodiment, a position of one or more layers 26 of the body 24 is adjustable to control the permeability of the body 24. For example, one or more of the layers 26 may be rotatable relative to another of the layers 26 of the body 24 to selectively increase or decrease the open area of the body 24 through which cooking vapors may flow. In embodiments including two or more layers 26 with openings or apertures, at least one of the layers 26 is movable to align the openings of adjacent layers, thereby increasing the open area of the body 24. Similarly, one or more of the layers 26 is movable to stagger or offset the openings of adjacent layers 26, thereby reducing the permeable area of body 24.

Alternatively, or in addition, one or more layers 26 of the body 24 may be selectively removable to adjust the permeability of the body 24. For example, elimination of one of a plurality of layers 26 of the body 24 may increase the open area through which cooking vapors may flow. Similarly, one or more layers 26 may be added to the body 24 to further reduce the open area of the body 24, thereby restricting a flow there through.

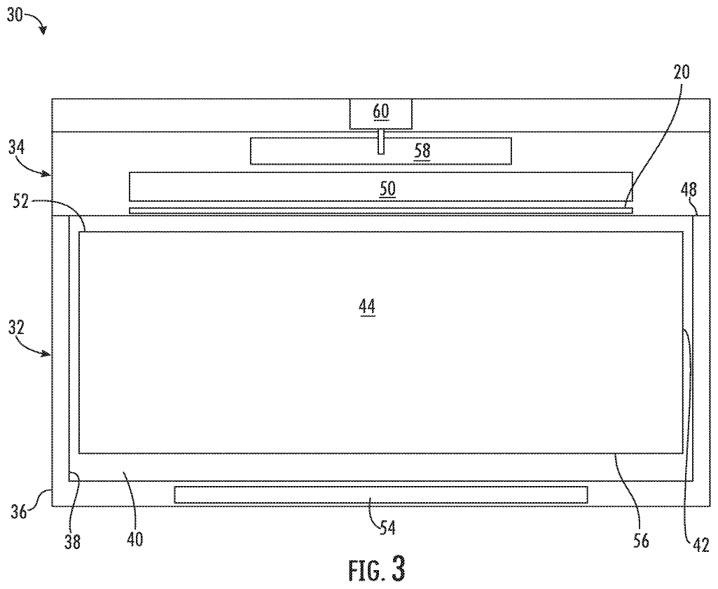

In an embodiment, the guard 20 is suitable for use within a countertop cooking system 30. An example of a cooking system 30 is illustrated in more detail in FIG. 3. As shown, the cooking system 30 includes a base 32 and a lid 34. The base 32 includes a housing 36 made of any suitable material, such as glass, aluminum, plastic, or stainless steel for example. A liner 38 may be disposed within the hollow interior 40 of the housing 36. The liner 38 may be formed from any suitable conductive material, such as aluminum for example. In an embodiment, the liner 38 forms an interior surface of the housing 36 and thereby defines the hollow interior 40 of the housing 36. Alternatively, the liner 38 may be offset from the interior surface of the housing 36. However, it should be understood that other components of the cooking system 30, or surfaces thereof, may also define the hollow interior 40.

A cooking container 42 is receivable within the hollow interior 40 of the housing 36. Although the cooking container 42 is described herein as being removable from the housing 36 of the base 32, embodiments where the cooking container 42 is integrally formed with the housing 36 are also contemplated herein. The cooking container 42, has an interior 44 designed to receive and retain one or more consumable products, such as food products for example, therein. Examples of food products suitable for use with the cooking system 30, include but are not limited to, meats, fish, poultry, bread, rice, grains, pasta, vegetables, fruits, and dairy products, among others. The cooking container 42 may be a pot formed from a ceramic, metal, or die cast aluminum material. In an embodiment, an interior surface of the cooking container 42 includes a nano-ceramic coating and an exterior surface of the cooking container 42 includes a silicone epoxy material. However, any suitable material capable of withstanding the high temperatures required for cooking food products is contemplated herein. Further, one or more handles 46 may be associated with the cooking container 42 to allow a user to easily grasp and manipulate the cooking container 42 relative to the housing 36.

One or more accessories, may be compatible for use with the cooking system 30. Examples of such accessories include, but are not limited to, a diffuser, a crisping insert, a grill plate, and a griddle for example. In such embodiments, the accessories may be receivable within the interior 40 of the housing 36, or alternatively, within the interior 44 of the cooking container 42.

Referring with more detail to the lid 34, it should be noted that the lid 34 is connectable to a surface of the cooking container 42 and/or housing 36 to close off entry to the interior 44 of the cooking container 42. Accordingly, a cooking volume may be defined between the interior 43 of the cooking container 42 and the closed lid 34, or alternatively, between the hollow interior 40 defined by the housing 36 and the closed lid 34. In an embodiment, a diameter of the lid 34 is generally complementary to a diameter of the housing 36 such that the lid 34 covers not only the cooking container 42, but also an upper surface 48 of the housing 36.

The lid 34 is movable relative to the base 32 between an open position and a closed position to selectively cover the hollow interior 40. For example, the lid 34 may be distinct and separable from the base 32, or the lid 34 may be movably connected to the base 32. In the illustrated, non-limiting embodiment, the lid 34 is pivotable or rotatable relative to the base 32 about a pivot axis P. However, other types or movement of the lid 34 are also within the scope of the disclosure. One or more fastening mechanisms (not shown) may, but need not be used to secure the lid 34 to the base 32 when the lid 34 is in the closed position. Any suitable type of fastening mechanism capable of withstanding the heat associated with the cooking system 30 is considered within the scope of the disclosure.

The cooking system 30 includes at least one heating element operable to impart heat to the cooking volume during one or more modes of operation of the cooking system 30. In the illustrated, non-limiting embodiment, a heating element 50 is positioned generally at or above an upper extent 52 of the cooking container 42, such as proximate a center of the interior 44 of the cooking container 42 for example. As shown, the at least one heating element 50 is mounted within the lid 34, and therefore completely outside of the cooking container 42, and vertically offset from the upper extent 52 thereof. Alternatively, or in addition, a heating element 54 may be disposed within the housing 36, generally adjacent the bottom 56 of the cooking container 42. However, it should be understood that embodiments where a heating element is arranged at another location within the base 32 and/or the lid 34 are also contemplated herein.

The at least one heating element 50, 54 may be capable of performing any suitable type of heat generation. For example, a heating element 50, 54 configured to heat the cooking container 42 or one or more food items located within the interior 44 of the cooking container 42 via conduction, convection, radiation, and induction are all within the scope of the disclosure. In the illustrated, non-limiting embodiment, the heating element 50 is operable to cook food within the cooking container 42 via a non-contact cooking operation. As used herein, the term “non-contact cooking operation” includes any cooking operation where a heating element or heat source is not arranged in direct or indirect contact with a food item, such as, but not limited to, convective and radiant heating. In such embodiments, the cooking system 30 additionally includes an air movement device 58, such as a fan for example, operable to circulate air within the cooking volume. The air is heated as it flows along its path of circulation, such as by flowing over a portion of the at least one heating element 50. In the illustrated, non-limiting embodiment, the air movement device 58 is driven by a motor 60 having a separate cooling mechanism coupled thereto.

In an embodiment, the heating element 54 is operable to cook food within the cooking container 42 via a contact cooking operation. As used herein, the term “contact cooking operation” includes a cooking operation where heat is transmitted via direct or indirect contact between a heating element or heat source and a food item, such as, but not limited to, conductive and inductive cooking. However, it should be understood that embodiments where the heating element 50 is operable to perform a contact cooking operation and embodiments where the heating element 54 is operable to perform a non-contact cooking operation are also within the scope of the disclosure.

Further, in embodiments including heating element 50 and heating element 54, it should be understood that the heating elements may be operable independently or in combination to apply one or more predetermined power settings to cook the food products within the cooking container. In operation, the heating elements 50, 54 may be capable of cooking the food independent of the loading of the food. In other words, the heating elements 50, 54 may be capable of cooking the food independent of the amount of food within the cooking container 42. The cooking operations that may be performed by the cooking system 30 include but are not limited to pressure cooking, steam cooking, slow cooking, searing, sautéing air frying, broiling, baking/roasting, dehydrating, and grilling.

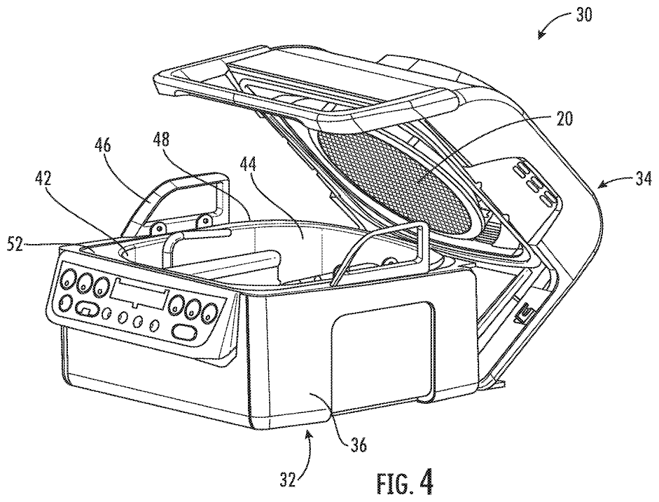

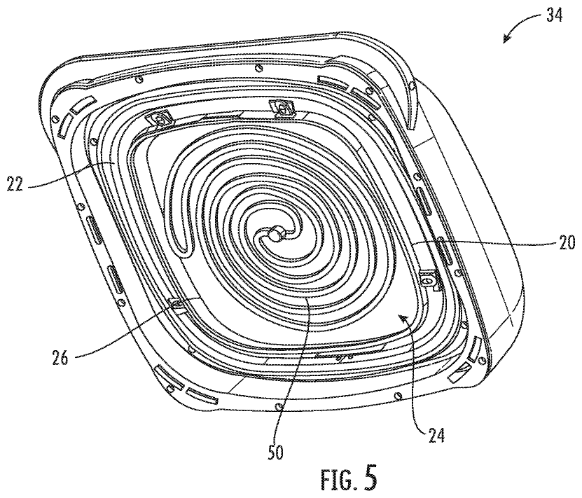

The guard 20 is mounted within the interior of the cooking system 30. The guard may be mounted via any suitable mounting mechanism, and may be removably or permanently arranged therein. As shown, the guard 20 may be located at any position between a food item being cooked within the cooking container 42 and a heating element 50, 54 of the cooking system 30. In the illustrated non-limiting embodiment, the guard is mounted within the lid 34 of the cooking system 30 adjacent heating element 50. As best shown in FIGS. 4 and 5, the body 24 of the guard 20 is sized such that body 24 substantially overlaps, and therefore protects, the entire surface of the heating element 50 facing the cooking volume. In an embodiment, a contour of the guard 20 is generally complementary to the shape of the heating element 50 that the guard is intended to protect. However, in other embodiments, best shown in FIG. 5, the contour of the guard 20 may be complementary to the lid 34.

As previously described, a permeability of the guard 20 may vary based on the cooking operation to be performed by the cooking system 30. In an embodiment, such as when the heating element 50 of the cooking system 30 is operational, the permeability of the guard 20 may be increased to allow air flow driven by the air movement device 58 to circulate through the guard 20. However, in such embodiments, the guard 20 is at least partially closed to restrict projectile matter generated during the cooking operation from contacting the heating element 50. By blocking at least a portion of the projectile matter generated during the cooking operation, smoke generation resulting from projectile matter contacting a hot heating element 50 is limited.

In embodiments where heating element 54 is operational, but heating element 50 is non-operational, it may be desirable to transform the guard to a fully closed position. For example, by closing off the heating element 50 (when non-operational) from communication with the interior 44 via the guard 20, the system can function in “wet” cooking modes (such as slow cooking, searing/sautéing, steaming, and pressure cooking) with lid 34 closed. If/when the guard 20 is impermeable to any fluid/air flow, the heater 50 is protected from projectiles and any steam that may travel up from the interior 44 during wet cooking modes. The guard 20 may then be transformed back into an open position (that still is generally impressible to grease and other projectiles but allows air/fluid flow from the interior 44 to the heating element 50) for “dry” cooking modes where fluid/air flow is beneficial (such as air frying, broiling, roasting/baking, dehydrating). As is discussed below, permeability adjustments (including full closing of heater 50 from the interior 44) may include adjustment of one, some, or all layers 26 and/or full removal and replacement of one, some, or all layers 26.

In an embodiment, the permeability of the guard 20 is adjusted prior to energizing any of the heating elements 50, 54 of the cooking system 30. Such adjustment may rotate or otherwise move one layer relative to another to block or otherwise decrease (via smaller size or non-linear pathway) the ability of particulate or in some cases fluid/air flow altogether from passing through the guard 20. In other embodiments, the guard 20 itself or layers 26 thereof may be removed from the cooking system 30 for some cooking operations and replaced for others (in some embodiments the guard 20 may be removed for dry modes and replaced for wet modes). In such embodiments, the guard 20 may simply be a plate without any openings that functions to removably cover the heating element 50 during the desired modes. Alternatively, the permeability of the guard 20 may be controlled during operation of the cooking system 30, automatically and in real time.

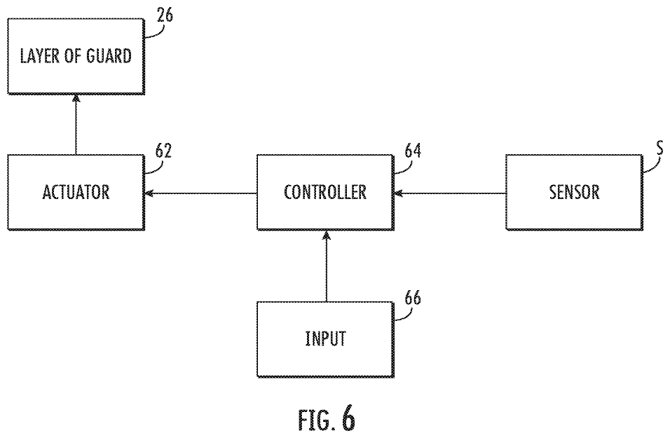

With reference now to FIG. 6, in an embodiment, one or more of the layers 26 of the body 24 is operably coupled to an actuator 62 or other movement mechanism. The cooking system 30 includes a controller 64 operably coupled to one or more inputs 66, such as buttons for example. The inputs 66 may be operable to select one of a plurality of modes of operation of the cooking system 30. In response to a mode of operation selected via an input 66, the controller 64 commands the actuator 62 to adjust of one or more of the layers 26 of the body 24 of the guard 20 to a desired configuration. Alternatively, or in addition, a sensor S for sensing one or more parameters within the cooking volume during a cooking operation may be operably coupled to the controller 64. In response to a condition detected within the cooking volume, such as reduced air flow for example, the controller 64 may command the actuator 62 to adjust a position of one or more of the layers 26 of the body 24.

The cooking system 30 having a guard 20 as illustrated and described herein has a reduced likelihood of smoking and grease splatter. As a result, the cooking system is easier for a user to operate and clean, thereby providing an enhanced user experience.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A cooking system comprising:
a housing having a hollow interior;
a heating element positioned above the hollow interior; and
a guard positioned below the heating element, the guard comprising a first layer and a second layer, wherein the second layer is removably attached to the guard to change a permeability of the guard, and wherein the guard is configured to restrict a flow between the heating element and the hollow interior.

2. The cooking system of claim 1, wherein the hollow interior is configured to receive a food product, and wherein the heating element is configured to heat the food product.

3. The cooking system of claim 1, wherein the flow comprises projectile matter associated with the food product.

4. The cooking system of claim 3, wherein the guard is configured to permit airflow between the heating element and the cooking container while blocking the projectile matter associated with the food product from contacting the heating element.

5. The cooking system of claim 1, wherein the heating element is configured to operate in a dry cooking mode comprising one or more of: air frying, broiling, roasting, baking, and dehydrating.

6. The cooking system of claim 5, wherein the second layer is configured to be removed from the guard in the dry cooking mode, thereby increasing a permeability of the guard.

7. The cooking system of claim 1, wherein the heating element is configured to operate in a wet cooking mode comprising one or more of: slow cooking, searing, sautéing, steaming, and pressure cooking.

8. The cooking system of claim 7, wherein the second layer is configured to be attached to the guard in the wet cooking mode, thereby decreasing a permeability of the guard.

9. The cooking system of claim 1, wherein the guard comprises metal.

10. A cooking system comprising:
a guard positioned between a heating element and a food product, the guard being configured to permit airflow between the heating element and the food product,
wherein the guard comprises a first layer and a second layer, the second layer being configured to be added to or removed from the guard to selectively block projectile matter associated with the food product from contacting the heating element.

11. A cooking system comprising:
a cooking container receivable within a housing;
a heating element positioned completely outside of the cooking container; and
a guard positioned between the heating element and the cooking container. the guard comprising a first layer and a second layer, wherein the guard is configured to restrict a flow between the heating element and the cooking container.

12. The cooking system of claim 11, wherein the guard is positioned completely outside of the cooking container and adjacent the heating element.

13. The cooking system of claim 11, wherein the guard is vertically offset from the cooking container.

14. The cooking system of claim 13, wherein the heating element is mounted within a lid disposed vertically above an upper extent of the cooking container.

15. The cooking system of claim 14, wherein the guard is mounted within the lid and positioned vertically below the heating element.

16. The cooking system of claim 11, wherein a distance between the second layer and the cooking container is shorter than a distance between the first layer and the cooking container.

17. The cooking system of claim 11, wherein the first layer and the second layer are spaced apart by an air gap.

18. The cooking system of claim 11, wherein a distance between the guard and an upper extent of the cooking container is shorter than a distance between the upper extent of the cooking container and a bottom surface of the cooking container.

19. The cooking system of claim 11, wherein the heating element is a first heating element, further comprising a second heating element positioned adjacent a bottom surface of the cooking container.

20. The cooking system of claim 19, wherein a distance between the second heating element and the bottom surface of the cooking container is shorter than a distance between the first heating element and the bottom surface of the cooking container.

21-30. (canceled)
